(19) United States
(12) Patent Application Publication
(10) Pub. No.: US 2013/0257870 A1
(43) Pub. Date: Oct. 3, 2013

(54) IMAGE PROCESSING APPARATUS, STEREOSCOPIC IMAGE DISPLAY APPARATUS, IMAGE PROCESSING METHOD AND COMPUTER PROGRAM PRODUCT

(71) Applicants: Yoshiyuki KOKOJIMA, Kanagawa (JP); Daisuke Hirakawa, Saitama (JP); Norihiro Nakamura, Kanagawa (JP); Takeshi Mita, Kanagawa (JP)

(72) Inventors: Yoshiyuki KOKOJIMA, Kanagawa (JP); Daisuke Hirakawa, Saitama (JP); Norihiro Nakamura, Kanagawa (JP); Takeshi Mita, Kanagawa (JP)

(21) Appl. No.: 13/710,552

(22) Filed: Dec. 11, 2012

(30) Foreign Application Priority Data
Apr. 2, 2012 (JP) 2012-084143

(51) Int. Cl. G06T 15/50

(52) U.S. Cl. CPC G06T 15/50
USPC 345/426

(57) ABSTRACT

According to an embodiment, an image processing apparatus includes an acquiring unit configured to acquire volume data of a three-dimensional image; and a superimposed image generating unit configured to generate a superimposed image that is made by superimposing light information on a depth image when a parallax image obtained by rendering the volume data from multiple viewpoints is displayed as a stereoscopic image. The light information represents a relationship between a position in a depth direction of the stereoscopic image and resolution of the stereoscopic image. The depth image is obtained by rendering the volume data from a depth viewpoint at which the entire volume data in the depth direction is viewable.

### CROSS-REFERENCE TO RELATED APPLICATION

This application is based upon and claims the benefit of priority from Japanese Patent Application No. 2012-084143, filed on Apr. 2, 2012; the entire contents of which are incorporated herein by reference.

### FIELD

Embodiments of the present invention generally relate to an image processing apparatus, a stereoscopic image display apparatus, an image processing method, and a computer program product.

### BACKGROUND

In recent years, a device capable of generating three-dimensional images (volume data) has been practically used in the field of medical diagnostic imaging devices such as an X-ray computed tomography (CT) device, a magnetic resonance imaging (MRI) device, or an ultrasonic diagnostic device. Moreover, a technique of rendering volume data from an arbitrary viewpoint has been practically used. In recent years, a technique of rendering volume data from multiple viewpoints to generate parallax images and displaying the parallax images stereoscopically on a stereoscopic image display apparatus has been investigated.

In order to display volume data on the stereoscopic image display apparatus effectively, it is important to control the amount of pop-out of volume data so as to fall within an appropriate range. The amount of pop-out can be controlled by changing an amount of parallax. When a display target object is drawn as a computer graphic (CG) like rendering of volume data, the amount of parallax may be changed by changing a camera interval. When the camera interval is widened, the amount of parallax increases, and when the camera interval is narrowed, the amount of parallax decreases. However, since the relationship between the camera interval and the amount of pop-out varies depending on a hardware specification of a stereoscopic image display apparatus, a method of controlling the amount of pop-out via the camera interval is neither a versatile nor intuitive method.

A conventional technique of intuitively controlling the amount of pop-out via an interface called a boundary box is known. The boundary box is a region which is to be reproduced on the stereoscopic image display apparatus in a virtual space of the CG. When the boundary box is disposed in the virtual space, an appropriate number of cameras are automatically disposed at an appropriate interval so that a region inside the boundary box is reproduced on the stereoscopic image display apparatus. When the depth range of the boundary box is widened, the camera interval is narrowed, and the amount of pop-out decreases. Conversely, when the depth range of the boundary box is narrowed, the camera interval increases, and the amount of pop-out increases. In this manner, it is possible to control the amount of pop-out of a display target object by changing the depth range of the boundary box.

However, in the conventional technique, it can be understood that the cross-section at the center of the boundary box has the highest resolution (density of light beams emitted from the pixels of the display panel), and the near-side surface and the far-side surface correspond to the lower limit of the resolution. However, since the resolution in the depth direction from the near-side surface to the far-side surface changes in a non-linear form, it is difficult to understand the display resolution at an optional inner position within the boundary box (in other words, any position in the depth direction of the boundary box).

### BRIEF DESCRIPTION OF THE DRAWINGS

FIG. 1 is a diagram illustrating a configuration example of an image display system of an embodiment;

FIG. 2 is a diagram for explaining an example of volume data according to the embodiment;

FIG. 3 is a diagram illustrating a configuration example of a stereoscopic image display apparatus according to the embodiment;

FIG. 4 is a schematic view illustrating a display unit according to the embodiment;

FIG. 5 is a schematic view illustrating the display unit viewed by a user (viewer) according to the embodiment;

FIG. 6 is a schematic view of a case where volume data according to the embodiment is displayed stereoscopically;

FIG. 7 is a diagram illustrating a configuration example of an image processing unit of a first embodiment;

FIG. 8 is a conceptual diagram of a case where the volume data according to the embodiment is rendered;

FIG. 9 is a diagram illustrating a detailed configuration example of a superimposed image generating unit according to the first embodiment;

FIG. 10 is a diagram illustrating an example of a first viewpoint and a depth viewpoint according to the embodiment;

FIG. 11 is a diagram illustrating an example of a depth image according to the embodiment;

FIG. 12 is a diagram illustrating an example of a superimposed image according to the embodiment;

FIG. 13 is a conceptual diagram illustrating an aspect where respective parallax images and a superimposed image according to the embodiment are combined;

FIG. 14 is a flowchart illustrating an operation example of a stereoscopic image display apparatus according to the first embodiment;

FIG. 15 is a diagram illustrating a configuration example of an image processing unit according to a modification;

FIG. 16 is a flowchart illustrating an operation example of a stereoscopic image display apparatus according to the modification;

FIG. 17 is a diagram illustrating a configuration example of an image processing unit according to a second embodiment;

FIG. 18 is a diagram illustrating a detailed configuration example of a superimposed image generating unit according to the second embodiment;

FIG. 19 is a diagram illustrating an example of an image in which an allowable line according to the second embodiment is superimposed on a superimposed image;

FIG. 20 is a flowchart illustrating an operation example of a stereoscopic image display apparatus according to the second embodiment;

FIG. 21 is a flowchart illustrating an operation example of a stereoscopic image display apparatus according to a modification;

FIG. 22 is a diagram illustrating a configuration example of an image processing unit according to a third embodiment;

FIG. 23 is a conceptual diagram of a case where a point of interest is designated by referring to a cross-sectional image according to the third embodiment;

FIG. 24 is a diagram illustrating an example of a coordinate system according to the third embodiment;

FIG. 25 is a conceptual diagram illustrating an aspect where multiple viewpoints according to the third embodiment are shifted in parallel;

FIG. 26 is a diagram illustrating an example of an image that is changed according to setting of a region of interest according to the third embodiment;

FIG. 27 is a diagram illustrating an example of setting a display position of the region of interest according to the third embodiment;

FIG. 28 is a diagram illustrating an example of a cross-section-of-interest according to the third embodiment; and

FIG. 29 is a flowchart illustrating an operation example of a stereoscopic image display apparatus according to the third embodiment.

### DETAILED DESCRIPTION

According to an embodiment, an image processing apparatus includes an acquiring unit configured to acquire volume data of a three-dimensional image; and a superimposed image generating unit configured to generate a superimposed image that is made by superimposing light information on a depth image when a parallax image obtained by rendering the volume data from multiple viewpoints is displayed as a stereoscopic image. The light information represents a relationship between a position in a depth direction of the stereoscopic image and resolution of the stereoscopic image. The depth image is obtained by rendering the volume data from a depth viewpoint at which the entire volume data in the depth direction is viewable.

Hereinafter, embodiments of an image processing apparatus, a stereoscopic image display apparatus, an image processing method, and a computer program product according to the present invention will be described in detail with reference to the accompanying drawings.

### First Embodiment

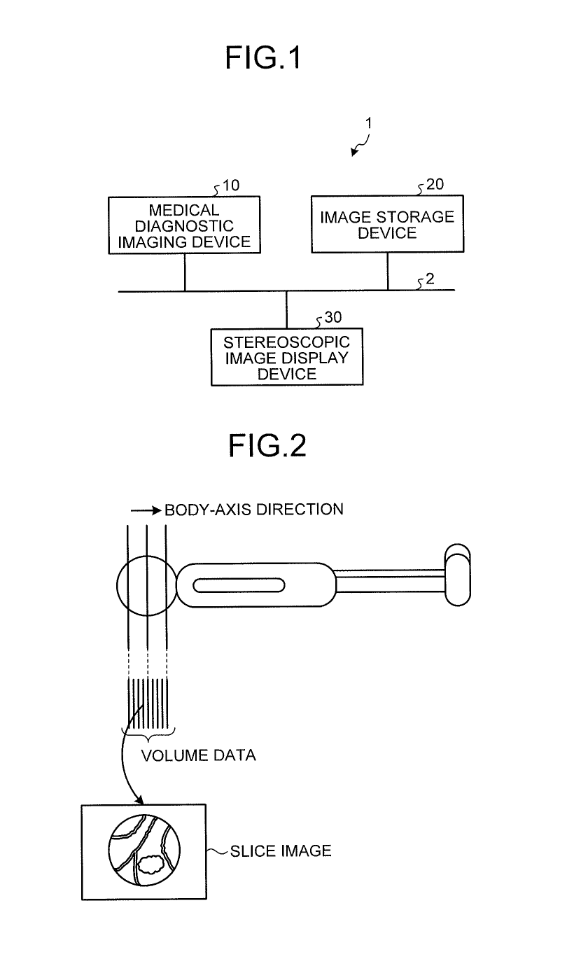

FIG. 1 is a block diagram illustrating a configuration example of an image display system 1 according to the present embodiment. As illustrated in FIG. 1, the image display system 1 includes a medical diagnostic imaging device 10, an image storage device 20, and a stereoscopic image display apparatus 30. The respective devices illustrated in FIG. 1 can communicate directly or indirectly with each other via a communication network 2, and the respective devices can transmit and receive three-dimensional images or the like to and from each other. The type of the communication network 2 is optional, and for example, the respective devices may be communicable with each other via a local area network (LAN) installed in a hospital. Moreover, for example, the respective devices may be communicable with each other via a network (cloud) such as the Internet.

The image display system 1 generates a stereoscopic image from volume data of the three-dimensional image generated by the medical diagnostic imaging device 10. Moreover, the image display system 1 displays the generated stereoscopic image on a display unit to thereby provide a three-dimensional image that can be stereoscopically viewed for a physician or an examination engineer who works in a hospital. A stereoscopic image is an image including multiple parallax images having different parallaxes. Hereinafter, the respective devices will be described in order.

The medical diagnostic imaging device 10 is a device that can generate volume data of a three-dimensional image. Examples of the medical diagnostic imaging device 10 include an X-ray diagnostic device, an X-ray computed tomography (CT) device, a magnetic resonance imaging (MRI) device, an ultrasonic diagnostic device, a single photon emission computed tomography (SPECT) device, a positron emission computed tomography (PET) device, a SPECT-CT device in which a SPECT device and an X-ray CT device are integrated, a PET-CT device in which a PET device and an X-ray CT device are integrated, and a group of these devices.

The medical diagnostic imaging device 10 generates volume data by imaging a subject. For example, the medical diagnostic imaging device 10 collects projection data or data of an MR signal by imaging a subject and reconstructs multiple (for example, 300 to 500 pieces of) slice images (cross-sectional images) taken along the body-axis direction of the subject to thereby generate volume data. Specifically, as illustrated in FIG. 2, the multiple slice images captured along the body-axis direction of the subject are the volume data. In the following description, the direction corresponding to the body-axis direction of the subject may be referred to as a depth direction of the volume data. In the example of FIG. 2, the volume data of the brain of a subject is generated. The projection data of the subject or the MR signal itself captured by the medical diagnostic imaging device 10 may be referred to as the volume data. Moreover, the volume data generated by the medical diagnostic imaging device 10 includes an image of an object serving as an observation target in a medical field, such as a bone, a blood vessel, a nerve, or a tumor.

The image storage device 20 is a database that stores three-dimensional images. Specifically, the image storage device 20 stores the volume data and the position information transmitted from the medical diagnostic imaging device 10 and archives the volume data and the position information.

The stereoscopic image display apparatus 30 is a device that displays multiple parallax images having different parallaxes so that a viewer can observe the stereoscopic images. The stereoscopic image display apparatus 30 may be one which employs a 3D display method such as, for example, an integral imaging method (II method) or a multi-view system. Examples of the stereoscopic image display apparatus 30 include a TV, a PC, or the like which enables viewers to view stereoscopic images with naked eyes. The stereoscopic image display apparatus 30 of the present embodiment performs a volume rendering process on the volume data acquired from the image storage device 20 and generates and displays a group of parallax images. The group of parallax images is a group of images generated by performing a volume rendering process on the volume data by moving a viewpoint position by a predetermined parallax angle and is made up of multiple parallax images having different viewpoint positions.

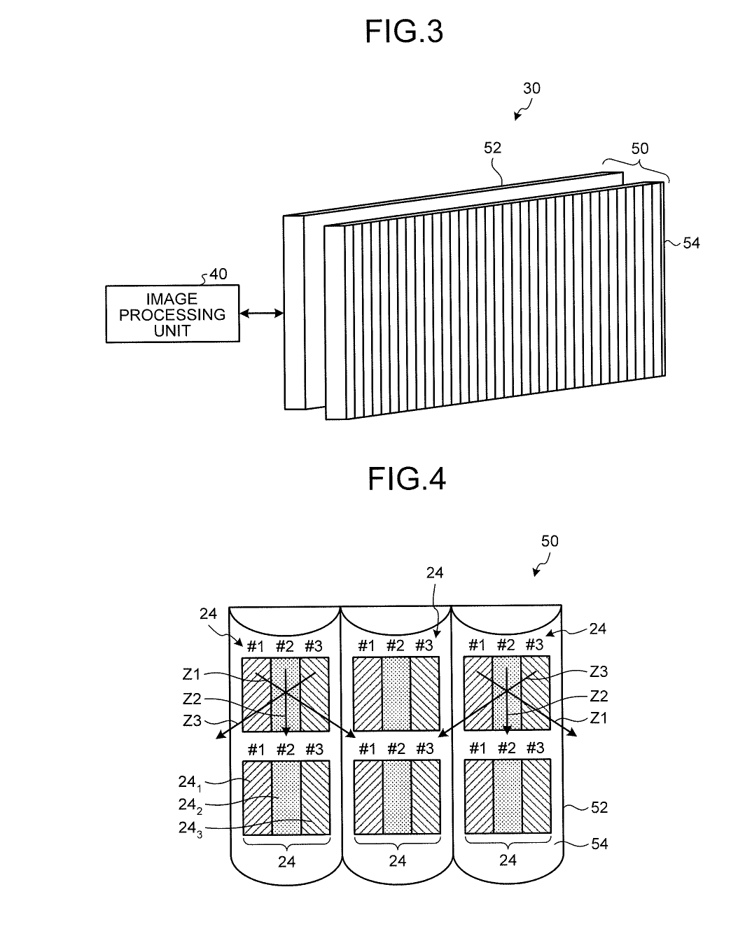

FIG. 3 is a diagram illustrating a configuration example of the stereoscopic image display apparatus 30. As illustrated in FIG. 3, the stereoscopic image display apparatus 30 includes an image processing unit 40 and a display unit 50. For example, the image processing unit 40 and the display unit 50 may be connected to each other via a communication network (network). The image processing unit 40 performs image processing on the volume data acquired from the image storage device 20. The detailed content of the image processing will be described below.

The display unit 50 displays the stereoscopic images generated by the image processing unit 40. As illustrated in FIG. 3, the display unit 50 includes a display panel 52 and a light beam control unit 54. The display panel 52 is a liquid crystal panel in which multiple sub-image elements (for example, R, G, and B) having color components are arranged in a matrix form in a first direction (the row direction (horizontal direction) in FIG. 3, for example) and a second direction (the column direction (vertical direction) in FIG. 3, for example). In this case, the sub-image elements of the respective RGB colors arranged in the first direction constitute one pixel. Moreover, an image displayed by a group of pixels in which adjacent pixels are arranged in the first direction by the number corresponding to the number of parallaxes is referred to as an elemental image. That is, the display unit 50 displays a stereoscopic image in which multiple elemental images are arranged in a matrix form. The arrangement of the sub-image elements of the display unit 50 may be another known arrangement. Moreover, the sub-image elements are not limited to the three colors of RGB. For example, the sub-image elements may be four colors or more.

A direct-view two-dimensional display, for example, an organic electroluminescence (EL), a liquid crystal display (LCD), a plasma display panel (PDP), or a projection display is used as the display panel 52. Moreover, the display panel 52 may include a backlight.

The light beam control unit 54 is disposed to face the display panel 52 with a gap interposed. The light beam control unit 54 controls an emission direction of the light beam from the respective pixels of the display panel 52. The light beam control unit 54 has a configuration in which multiple optical apertures for emitting light beams are arranged in the first direction so as to extend in a straight line shape. For example, a lenticular sheet in which multiple cylindrical lenses are arranged, a parallax barrier in which multiple slits are arranged, or the like is used as the light beam control unit 54. The optical apertures are disposed so as to correspond to the respective elemental images of the display panel 52.

In the present embodiment, although the stereoscopic image display apparatus 30 has a vertical stripe arrangement in which the sub-image elements of the same color component are arranged in the second direction, and each color component is repeatedly arranged in the first direction, the present invention is not limited to this. Moreover, in the present embodiment, although the light beam control unit 54 is disposed so that the extension direction of the optical aperture is identical to the second direction of the display panel 52, the present invention is not limited to this. For example, the light beam control unit 54 may be disposed so that the extension direction of the optical aperture is inclined with respect to the second direction of the display panel 52.

FIG. 4 is a schematic view illustrating a partial region of the display unit 50 in an enlarged scale. Symbols #1 to #3 in FIG. 4 represent the identification information of the respective parallax images. In this example, a parallax number uniquely assigned to each of the parallax images is used as the identification information of the parallax images. Pixels having the same parallax number are pixels that display the same parallax images. In the example illustrated in FIG. 4, the pixels of the parallax images specified by the respective parallax numbers are arranged in the order of parallax numbers 1 to 3 to form an elemental image 24. In this example, although a case where the number of parallaxes is 3 (parallax numbers 1 to 3) is illustrated by way of an example, the present invention is not limited to this, and the different number of parallaxes may be used (for example, 9 parallaxes of parallax numbers 1 to 9).

As illustrated in FIG. 4, in the display panel 52, the elemental images 24 are arranged in a matrix form in the first and second directions. For example, when the number of parallaxes is 3, the respective elemental images 24 are a group of pixels in which a pixel 24₁ of a parallax image #1, a pixel 24₂ of a parallax image #2, and a pixel 24₃ of a parallax image #3 are arranged in order in the first direction.

In the respective elemental images 24, light beams emitted from the pixels (pixels 24₁ to 24₃) of the respective parallax images reach the light beam control unit 54. Moreover, the moving direction and the spreading of the light beams are controlled by the light beam control unit 54, and the light beams are emitted toward the entire surface of the display unit 50. For example, in the respective elemental images 24, the light beams emitted from the pixel 24₁ of the parallax image #1 are emitted in the direction indicated by arrow Z1. Moreover, in the respective elemental images 24, the light beams emitted from the pixel 24₂ of the parallax image #2 are emitted in the direction indicated by arrow Z2. Moreover, in the respective elemental images 24, the light beams emitted from the pixel 24₃ of the parallax image #3 are emitted in the direction indicated by arrow Z3. In this manner, in the display unit 50, the emission direction of the light beams emitted from the respective pixels of the respective elemental images 24 is adjusted by the light beam control unit 54.

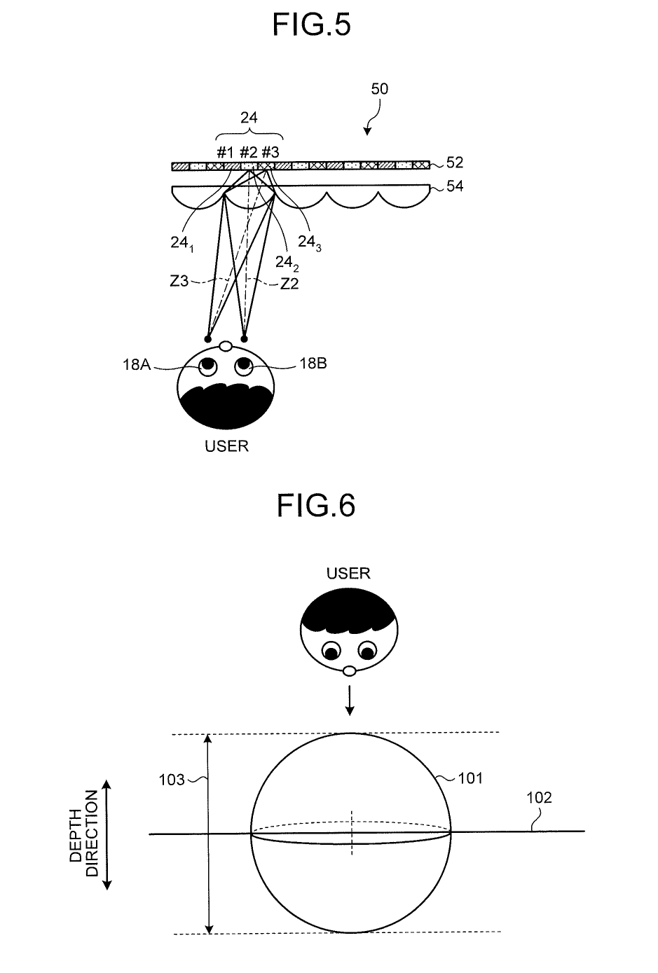

FIG. 5 is a schematic view illustrating a state where a user (viewer) observes the display unit 50. When a stereoscopic image made up of multiple elemental images 24 is displayed on the display panel 52, the user observes the pixels of different parallax images included in the elemental images 24 in a left eye 18A and a right eye 18B. In this way, by displaying images having different parallaxes in the left eye 18A and the right eye 18B of the user, the user can observe the stereoscopic image.

FIG. 6 is a conceptual diagram of a case where volume data of the brain illustrated in FIG. 2 is displayed stereoscopically. The symbol 101 in FIG. 6 represents a stereoscopic image of the volume data of the brain. The symbol 102 in FIG. 6 represents a screen surface of the display unit 50. The screen surface represents a surface that neither pops out to the near side nor sinks to the far-side in a stereoscopic view. Since the density of the light beams emitted from the pixels of the display panel 52 decreases as the light beams move away from the screen surface 102, the resolution of the image deteriorates. Thus, in order to display the entire volume data of the brain, for example, with high resolution, it is necessary to take a stereoscopically displayable range 103 of the display unit 50 into consideration. The stereoscopically displayable range 103 represents a region (display limit) in the depth direction in which the display unit 50 can display a stereoscopic image. Specifically, as illustrated in FIG. 6, it is necessary to set various parameters (for example, a camera interval, an angle, a position, and the like when creating a stereoscopic image) so that the entire volume data 101 of the brain falls within the stereoscopically displayable range 103 when the volume data 101 is displayed stereoscopically. The stereoscopically displayable range 103 is a parameter that is determined depending on the specification and the standard of the display unit 50, and may be stored in a memory (not illustrated) in the stereoscopic image display apparatus 30 and be stored in an external device.

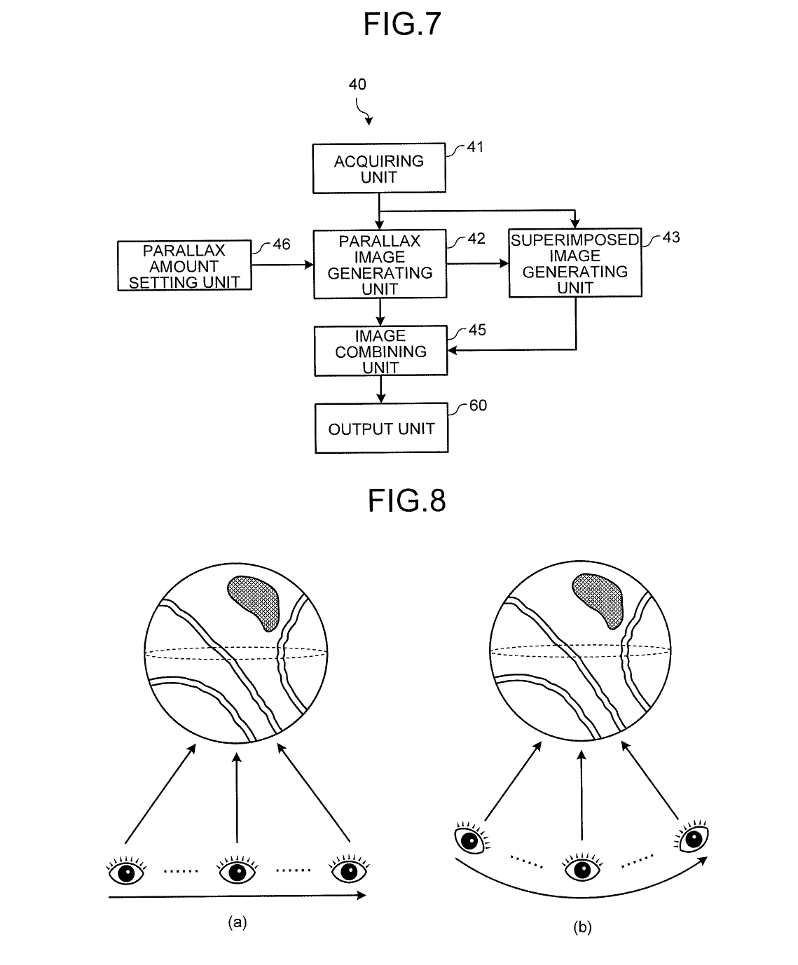

Next, a detailed content of the image processing unit 40 will be described. FIG. 7 is a block diagram illustrating a configuration example of the image processing unit 40. As illustrated in FIG. 7, the image processing unit 40 includes an acquiring unit 41, a parallax image generating unit 42, a superimposed image generating unit 43, an image combining unit 45, a parallax amount setting unit 46, and an output unit 60.

The acquiring unit 41 accesses the image storage device 20 to acquire the volume data generated by the medical diagnostic imaging device 10. The volume data may include position information for specifying the positions of respective organs such as a bone, a blood vessel, a nerve, or a tumor. The format of the position information is optional. For example, the position information may have a format in which identification information for identifying the type of an organ is managed in correlation with a group of voxels that constitute the organ, and may have a format in which identification information for identifying the type of an organ to which a voxel is included is added to each of the voxels included in the volume data. The volume data may include information on the coloring and permeability when the respective organs are rendered.

The parallax image generating unit 42 generates parallax images (a group of parallax images) of the volume data by rendering the volume data acquired by the acquiring unit 41 from multiple viewpoints. In rendering of the volume data, various existing volume rendering techniques can be used. FIG. 8 is a conceptual diagram of a case where volume data is rendered from multiple viewpoints. Illustrated in (a) of FIG. 8 is an example in which multiple viewpoints are arranged at equal intervals on a straight line. Illustrated in (b) of FIG. 8 is an example in which multiple viewpoints are arranged in a radial form. A projection method when performing the volume rendering may be parallel projection or perspective projection. Moreover, a projection method using parallel projection and perspective projection in combination may be used.

The description is continued by returning to FIG. 7. The parallax amount setting unit 46 sets the interval (camera interval) of the multiple viewpoints used when the parallax image generating unit 42 performs rendering. In this example, the camera interval is set so that the center (gravity center) of the volume data is displayed on the screen surface.

The superimposed image generating unit 43 generates a depth image obtained by rendering the volume data from a depth viewpoint which is a viewpoint different from the multiple viewpoints used when the parallax image generating unit 42 performs rendering and at which the entire volume data in the depth direction can be observed. Moreover, the superimposed image generating unit 43 generates a superimposed image obtained by superimposing light information that represents the relationship between the position in the depth direction (the normal direction of the screen surface) of the stereoscopic image and the resolution (density of light beams emitted from the pixels of the display panel 52) of the stereoscopic image when the parallax image generated by the parallax image generating unit 42 is displayed on the display unit 50 as a stereoscopic image, on the depth image. The detailed configuration and operation of the superimposed image generating unit 43 will be described below.

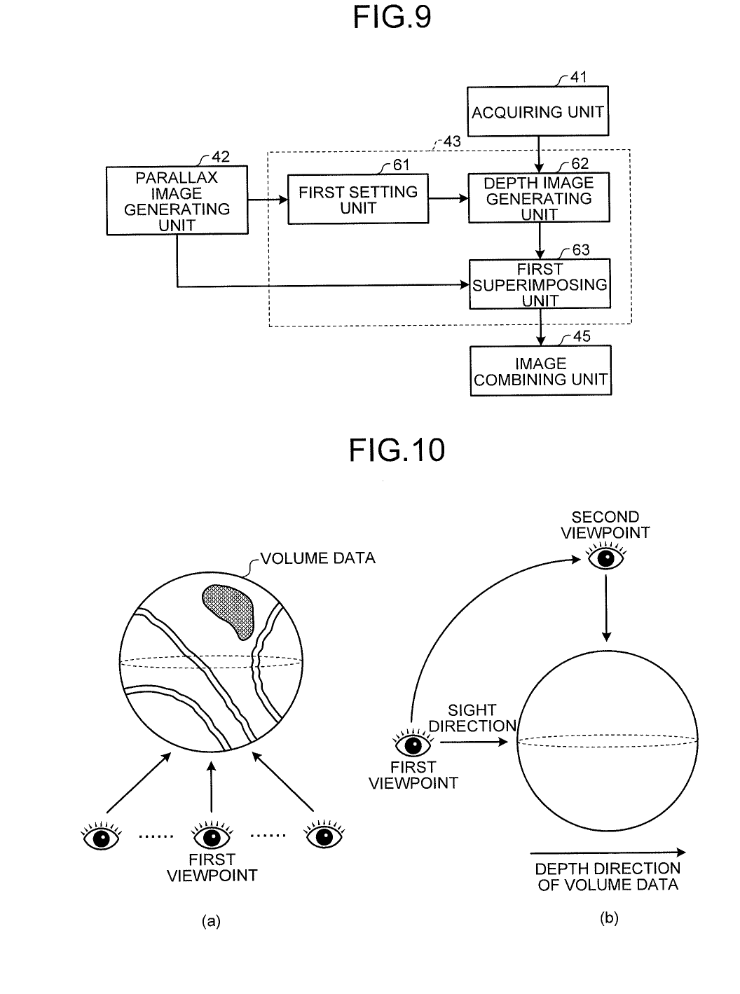

FIG. 9 is a diagram illustrating an example of a detailed configuration of the superimposed image generating unit 43. As illustrated in FIG. 9, the superimposed image generating unit 43 includes a first setting unit 61, a depth image generating unit 62, and a first superimposing unit 63.

The first setting unit 61 sets the depth viewpoint described above. More specifically, the first setting unit 61 selects one of the multiple viewpoints used when the parallax image generating unit 42 performs rendering, and sets a viewpoint on a plane whose normal line corresponds to a straight line perpendicular to a vector that extends in the sight direction from the selected viewpoint (referred to as a first viewpoint) as a depth viewpoint. In the present embodiment, as illustrated in (a) of FIG. 10, first, the first setting unit 61 selects a viewpoint at the center of the multiple viewpoints used when the parallax image generating unit 42 performs rendering as the first viewpoint. For example, when the number of parallaxes is an even number (the number of viewpoints is an even number), the central viewpoint may be calculated by performing interpolation or the like, and the calculated central viewpoint may be selected as the first viewpoint. Subsequently, as illustrated in (b) of FIG. 10, the first setting unit 61 sets a point obtained by rotating the first viewpoint by 90 degrees about the central point (gravity center) of the volume data as a second viewpoint (depth viewpoint). The present invention is not limited to this, and a method of setting the depth viewpoint is optional. In any case, the depth viewpoint may be a viewpoint at which the entire volume data in the depth direction can be observed (in an overview).

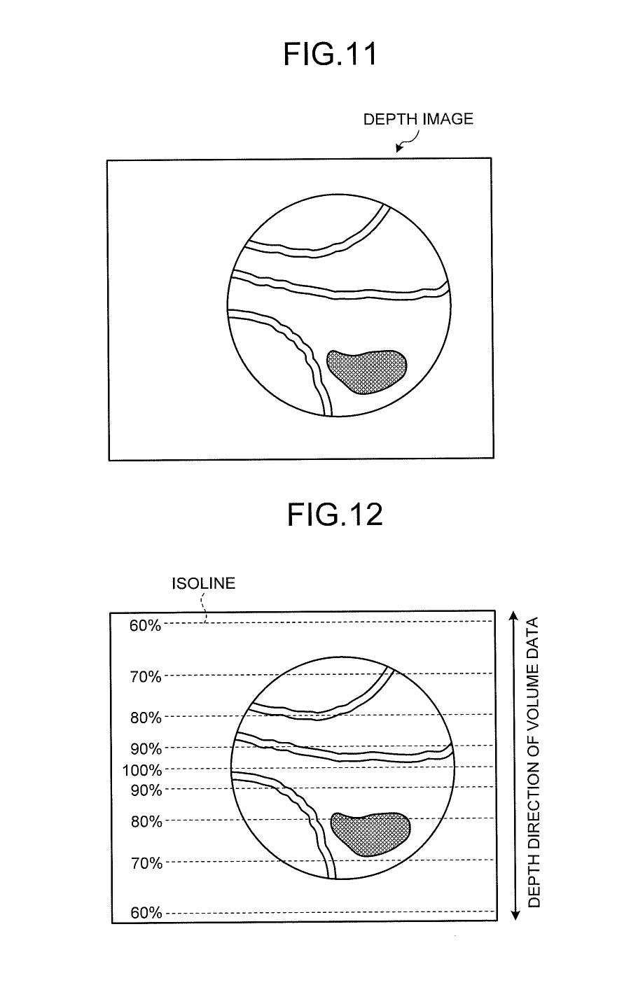

The description is continued by returning to FIG. 9. The depth image generating unit 62 generates a depth image by rendering the volume data from the depth viewpoint set by the first setting unit 61. FIG. 11 is a diagram illustrating an example of the depth image generated by the depth image generating unit 62.

The description is continued by returning to FIG. 9. The first superimposing unit 63 calculates isosurfaces each representing a surface on which the resolution when the parallax image is displayed on the display unit 50 as a stereoscopic image is equal. More specifically, the first superimposing unit 63 calculates the isosurfaces based on the interval of the multiple viewpoints used when the parallax image generating unit 42 performs rendering and information representing the characteristics of the light beams emitted from the display unit 50. Here, the relationship between the distance Z from the screen surface in the depth direction and the spatial frequency (that can be detected from the resolution) β can be expressed by Equation (1) below.

Zn=L/(2×((L+g)/L)×psp/g×β+1)

Zf=−L/(2×((L+g)/L)×psp/g×β1) (1)

In Equation (1), Zn represents the distance in the depth direction from the screen surface to the position at which the resolution on the front side is β, and Zf represents the distance in the depth direction from the screen surface to the position at which the resolution on the inner side is β. Moreover, L represents an observation distance representing the distance from the screen surface to the position at which the viewer observes the stereoscopic image. Further, g represents a focal distance in air. Further, psp represents a horizontal width of a subpixel (sub-image element). Each of L, g, and psp is a constant that is determined by the specification (hardware specification) of the display unit 50.

In this example, the values L, g, and psp described above and Equation (1) are stored in a memory (not illustrated). The first superimposing unit 63 reads the values L, g, and psp described above and Equation (1) from the memory (not illustrated) and substitutes the value of an optional resolution β into Equation (1). In this way, the first superimposing unit 63 can calculate how far the distance of the position at which the resolution β is obtained is separated from the screen surface in the depth direction. For example, in order to calculate a position at which the resolution β₀ on the screen surface decreases to 90%, resolution β₀×0.9 may be substituted into the value p of Equation (1).

Moreover, the values Zn and Zf are corrected according to the value of the interval of the multiple viewpoints set by the parallax amount setting unit 46. More specifically, when the value of the interval of the multiple viewpoints set by the parallax amount setting unit 46 is equal as a predetermined default value, the values Zn and Zf are the same as the values obtained by Equation (1). However, for example, when the value of the interval of the multiple viewpoints set by the parallax amount setting unit 46 is twice the default value, the values Zn and Zf are corrected to the values that are half the values obtained by Equation (1). Moreover, for example, when the value of the interval of the multiple viewpoints set by the parallax amount setting unit 46 is half the default value, the values Zn and Zf are corrected to the values that are twice the values obtained by Equation (1).

As above, the first superimposing unit 63 calculates the isosurfaces based on the interval of the multiple viewpoints set in advance by the parallax amount setting unit 46 and the information (in this example, the values L, g, and psp described above and Equation (1)) representing the characteristics of the light beams emitted from the display unit 50. However, the method of calculating the isosurfaces is not limited to this. Moreover, the first superimposing unit 63 draws isolines that represent the isosurfaces as viewed from the depth viewpoint, respectively. The drawn isolines can be understood as light information that represents the relationship between the position in the depth direction of the stereoscopic image and the resolution of the stereoscopic image when the parallax image is displayed on the display unit 50 as a stereoscopic image. The first superimposing unit 63 superimposes the drawn isolines (light information) on the depth image and generates a superimposed image which represents the display resolution at an optional position in the depth direction of the volume data. FIG. 12 is a diagram illustrating an example of the superimposed image generated by the first superimposing unit 63. In the example of FIG. 12, the resolution of the screen surface is set to 100%, and the resolution represented by each of the isolines is denoted to the left side of the isolines as a percentage to the resolution of the screen surface. However, the present invention is not limited to this. For example, the value of the resolution itself may be displayed in correlation with the isoline.

Moreover, the positions of the volume data displayed on the screen surface and the entire depth amount (which includes the amount of pop-out toward the near side from the screen surface plus the amount of sinking into the far side from the screen surface) when the volume data is displayed stereoscopically are determined in advance according to the interval of the multiple viewpoints set by the parallax amount setting unit 46. In the example of FIG. 12, the camera interval is set so that the central point (gravity center) of the volume data is displayed on the screen surface.

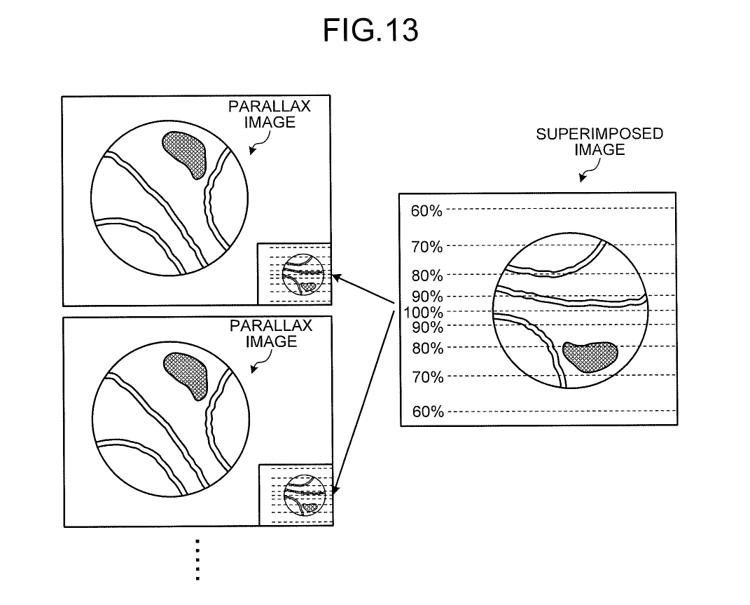

The description is continued by returning to FIG. V. As illustrated in FIG. 13, the image combining unit 45 combines the superimposed image generated by the superimposed image generating unit 43 with each of the respective parallax images of the volume data generated by the parallax image generating unit 42.

The output unit 60 outputs (displays) the image combined by the image combining unit 45 on the display unit 50. The present invention is not limited to this, and for example, the image combining unit 45 may be not provided, and the output unit 60 may output only the superimposed image generated by the superimposed image generating unit 43 to the display unit 50. Moreover, for example, the output unit 60 may selectively output the superimposed image generated by the superimposed image generating unit 43 and any one of the respective parallax images generated by the parallax image generating unit 42 to the display unit 50. Further, for example, the output unit 60 may output the superimposed image generated by the superimposed image generating unit 43 and the respective parallax images generated by the parallax image generating unit 42 to another monitor (display unit).

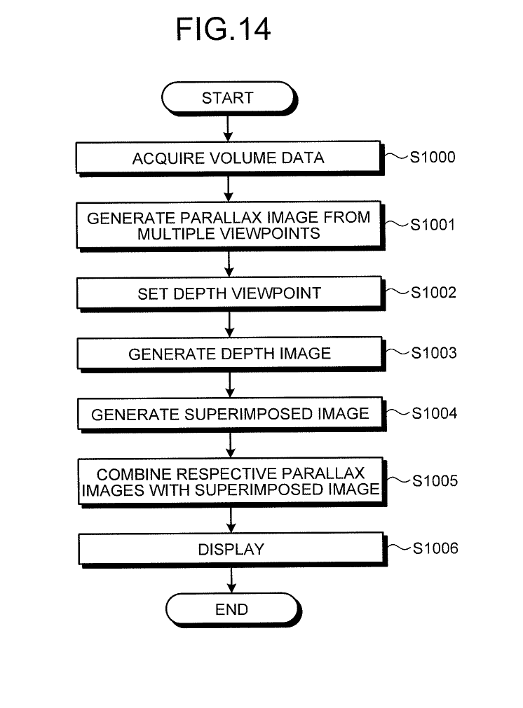

Next, an operation example of the stereoscopic image display apparatus 30 according to the present embodiment will be described with reference to FIG. 14. FIG. 14 is a flowchart illustrating the operation example of the stereoscopic image display apparatus 30. First, in step S1000, the acquiring unit 41 accesses the image storage device 20 to acquire the volume data generated by the medical diagnostic imaging device 10. In step S1001, the parallax image generating unit 42 generates parallax images (a group of parallax images) of the volume data by rendering the volume data acquired by the acquiring unit 41 from multiple viewpoints.

In step S1002, the first setting unit 61 sets a depth viewpoint. In step S1003, the depth image generating unit 62 generates a depth image by rendering the volume data from the depth viewpoint. In step S1004, the first superimposing unit 63 calculates isosurfaces based on the interval of the multiple viewpoints used when the parallax image generating unit 42 performs rendering and the information representing the characteristics of the light beams emitted from the display unit 50 and draws isolines that represent the isosurfaces as viewed from the depth viewpoint, respectively. Moreover, the first superimposing unit 63 generates a superimposed image by superimposing the drawn isolines on the depth image.

In step S1005, the image combining unit 45 combines the respective parallax images of the volume data generated by the parallax image generating unit 42 and the superimposed image generated by the superimposed image generating unit 43. In step S1006, the output unit 60 displays the image combined by the image combining unit 45 on the display unit 50.

As described above, in the present embodiment, when a parallax image obtained by rendering volume data from multiple viewpoints is displayed as a stereoscopic image, isolines (light information) representing the relationship between the position in the depth direction of the stereoscopic image and the resolution of the stereoscopic image are superimposed on a depth image obtained by rendering the volume data from a depth viewpoint to obtain and display the superimposed image. In this way, the viewer can understand the exact resolution at an optional position in the depth direction of the volume data.

### Modification of First Embodiment

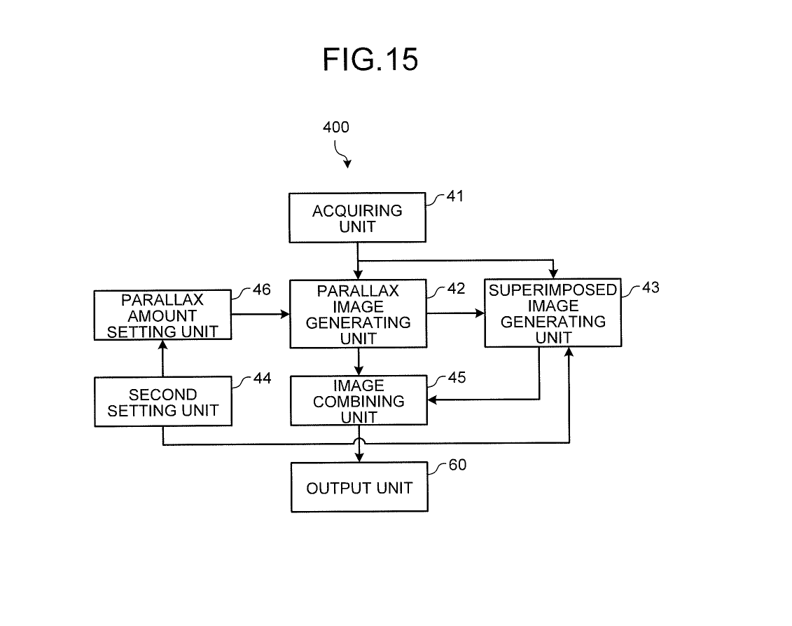

For example, the positional relationship between the depth image and the isolines or the interval of the isolines (the light information) may be changed according to the input by the viewer. FIG. 15 is a diagram illustrating a configuration example of an image processing unit 400 according to a modification example of the first embodiment. The same portions as those of the first embodiment will be denoted by the same reference numerals, and description thereof will not be provided.

As illustrated in FIG. 15, the image processing unit 400 is different from that of the first embodiment in that the image processing unit 400 further includes a second setting unit 44. The second setting unit 44 changeably sets the positional relationship between the depth image and the isolines or the interval of the isolines according to the input by the viewer. In this example, the stereoscopic image (group of parallax images) and the superimposed image of the volume data displayed on the display unit 50 in a state where the setting of the second setting unit 44 are not reflected will be referred to as a default stereoscopic image and a default superimposed image, respectively; and both images will be referred to as default images when both images are not distinguished.

For example, the viewer can perform an input operation of changing the positional relationship between the depth image and the isolines or the interval of the isolines by operating a mouse while viewing the default image displayed on the display unit 50 to designate a depth image or an isoline using a mouse cursor and moving the designated depth image or isoline in the vertical direction (the depth direction in FIG. 12) of the screen through dragging or wheeling the mouse. The present invention is not limited to this, and an input method for changing the positional relationship between the depth image and the isolines or the interval of the isolines is optional. In this way, the viewer can perform an input operation of changing the position of the volume data displayed on the screen surface and perform an input operation of changing (widening or narrowing) the interval of the isolines.

The superimposed image generating unit 43 changes (regenerates) the superimposed image according to the content of the setting of the second setting unit 44. Moreover, the parallax amount setting unit 46 changes the interval of the multiple viewpoints used when the parallax image generating unit 42 performs rendering according to the content of the setting of the second setting unit 44. Moreover, the parallax image generating unit 42 changes (regenerates) the parallax image by rendering the volume data from the multiple viewpoints of which the interval is changed by the parallax amount setting unit 46. Moreover, the image combining unit 45 combines the changed superimposed image with the respective changed parallax images of the volume data. The output unit 60 displays the image combined by the image combining unit 45 on the display unit 50.

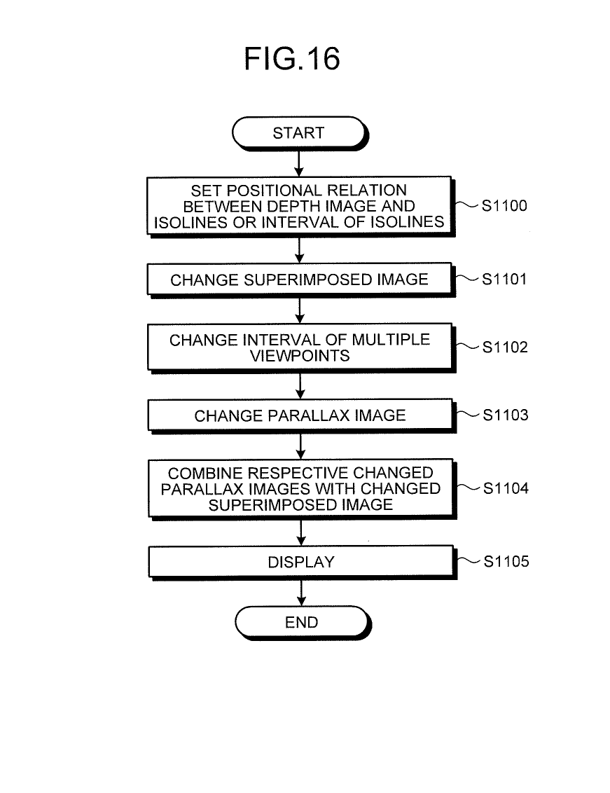

Next, an operation example of the stereoscopic image display apparatus when the viewer performs an input operation of changing the positional relationship between the depth image and the isolines or the interval of the isolines while viewing the default image displayed on the display unit 50 will be described. FIG. 16 is a flowchart illustrating the operation example of the stereoscopic image display apparatus in this case. First, in step S1100, the second setting unit 44 sets the positional relationship between the depth image and the isolines or the interval of the isolines according to the input by the viewer. In step S1101, the superimposed image generating unit 43 changes the superimposed image according to the content of the setting of the second setting unit 44. In step S1102, the parallax amount setting unit 46 changes the interval (camera interval) of the multiple viewpoints according to the content of the setting of the second setting unit 44. In step S1103, the parallax image generating unit 42 changes (regenerates) the parallax image by rendering the volume data from the multiple viewpoints of which the interval is changed by the amount of parallax setting unit 46. The processes of steps S1102 and S1103 may be performed earlier than the process of step S1101 and may be performed in parallel with the process of step S1101.

In step S1104, the image combining unit 45 combines the respective changed parallax images of the volume data with the changed superimposed image. In step S1105, the output unit 60 displays the image combined by the image combining unit 45 on the display unit 50.

As described above, in this example, the second setting unit 44 changeably sets the positional relation between the depth image and the isolines or the interval of the isolines according to the input by the viewer. Moreover, since the amount of pop-out (amount of parallax) of the volume data is changed according to the content of the setting of the second setting unit 44, the viewer can control the display resolution at an optional position of the volume data.

### Second Embodiment

Next, a second embodiment will be described. The second embodiment is different from the first embodiment in that the second embodiment includes a function (hereinafter referred to as an allowable line display function) of drawing allowable lines as viewed from a depth viewpoint, of a surface (allowable value surface) on which the resolution when a parallax image of volume data is displayed as a stereoscopic image is equal to a predetermined allowable value and displaying the drawn allowable lines that are superimposed on a superimposed image. This will be described in detail below. The same portions as those of the first embodiment will be denoted by the same reference numerals, and description thereof will not be provided.

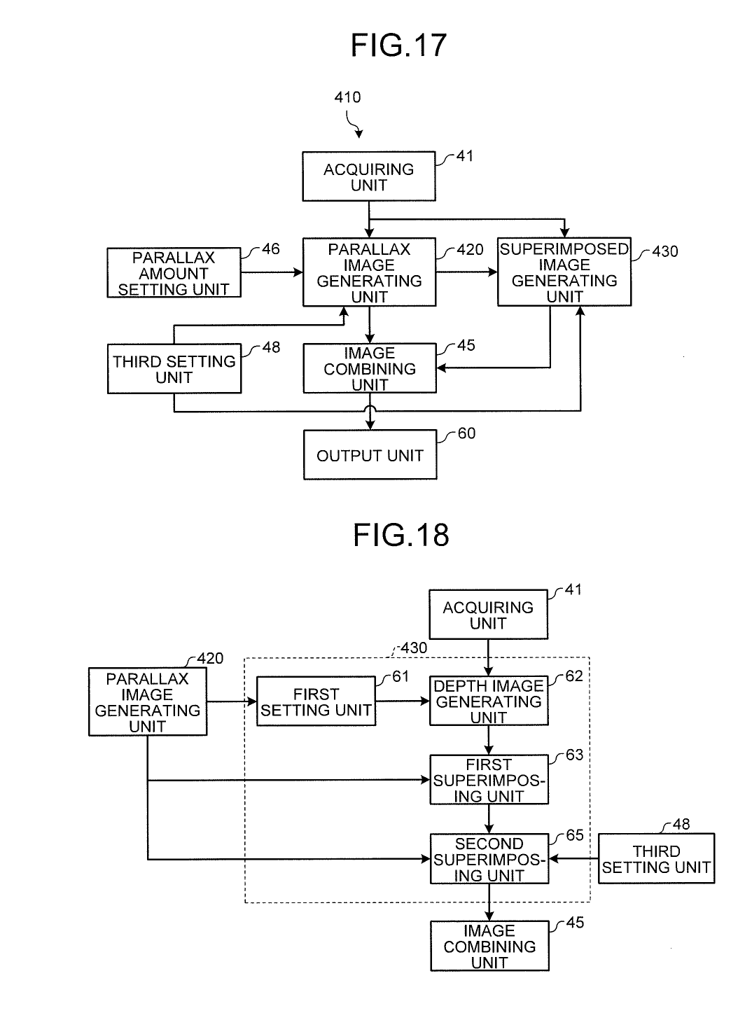

FIG. 17 is a diagram illustrating a configuration example of an image processing unit 410 according to the second embodiment. As illustrated in FIG. 17, the image processing unit 410 is different from that of the first embodiment in that the image processing unit 410 further includes a third setting unit 48. The third setting unit 48 switches between on and off of the allowable line display function according to the input by the viewer. When the allowable line display function is set to on (enable), the third setting unit 48 sets a predetermined allowable value and transmits the set allowable value to a parallax image generating unit 420 and a superimposed image generating unit 430.

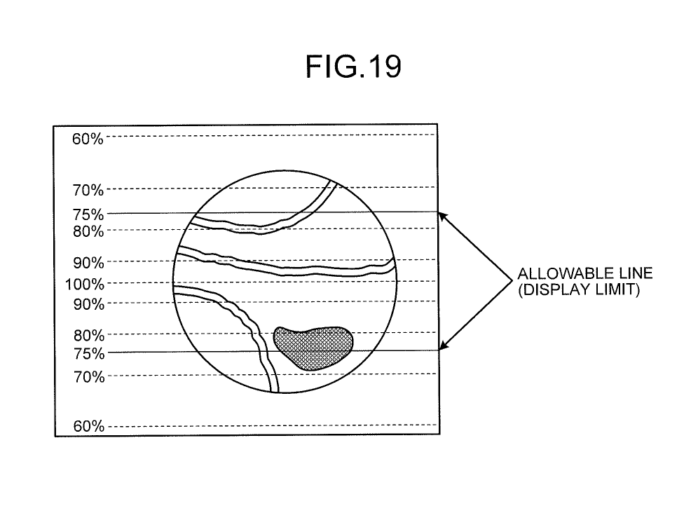

FIG. 18 is a diagram illustrating an example of a detailed configuration of the superimposed image generating unit 430 according to the present embodiment. As illustrated in FIG. 18, the superimposed image generating unit 430 is different from that of the first embodiment in that the superimposed image generating unit 430 further includes a second superimposing unit 65. When the allowable line display function is set to on (the predetermined allowable value is transmitted from the third setting unit 48), the second superimposing unit 65 calculates an allowable value surface representing a surface on which the resolution when a parallax image is displayed on the display unit 50 as a stereoscopic image is equal to the predetermined allowable value. More specifically, similarly to the method of calculating the isosurfaces described above, the second superimposing unit 65 calculates allowable value surfaces based on the interval of the multiple viewpoints used when the parallax image generating unit 420 performs rendering and the information representing the characteristics of the light beams emitted from the display unit 50. Moreover, the second superimposing unit 65 draws allowable lines that represent the allowable value surfaces as viewed from the depth viewpoint, respectively and superimposes the drawn allowable lines on the superimposed image as illustrated in FIG. 19. The allowable lines can be understood as lines that represent a display limit in the depth direction of the volume data. In the example of FIG. 19, although the resolution (percentage to the resolution (100%) of the screen surface) of the allowable value is set to 75%, the present invention is not limited to this, and the allowable value may be set to an optional value.

The description is continued by returning to FIG. 17. The parallax image generating unit 420 generates a parallax image so that a region of the volume data in which the resolution when the parallax image is displayed as a stereoscopic image is smaller than the allowable value is not displayed. More specifically, the parallax image generating unit 420 does not perform sampling along an arbitrary line of sight (ray of light) with respect to the region of the volume data in which the resolution when the parallax image is displayed as the stereoscopic image is smaller than the allowable value.

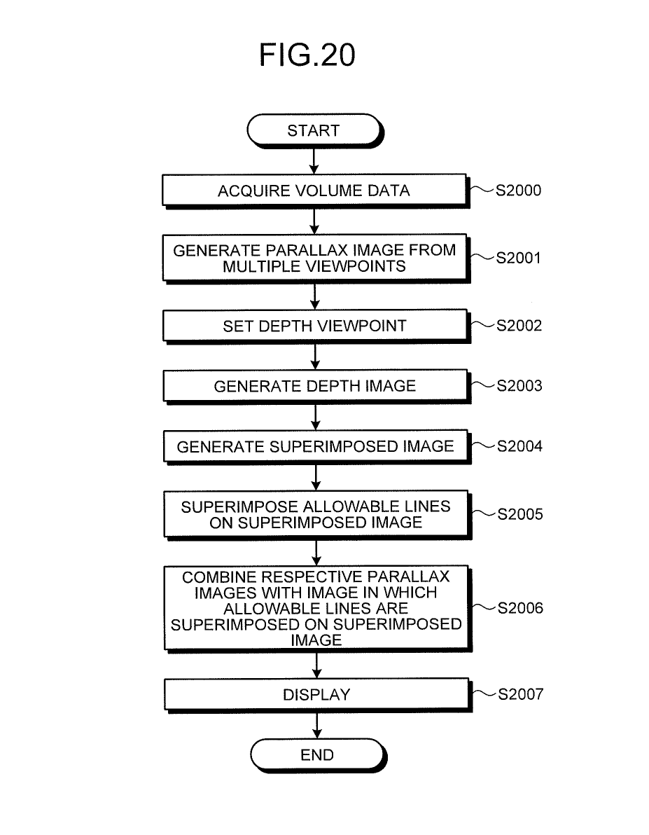

Next, an operation example of a stereoscopic image display apparatus when the allowable line display function is set to on will be described with reference to FIG. 20. First, in step S2000, the acquiring unit 41 accesses the image storage device 20 to acquire the volume data generated by the medical diagnostic imaging device 10. In step S2001, the parallax image generating unit 420 generates a parallax image obtained by rendering the volume data so that a region of the volume data acquired by the acquiring unit 41 in which the resolution when the parallax image is displayed as a stereoscopic image is smaller than the allowable value is not displayed.

The processes of steps S2002 to 52004 are the same as the processes of step S1002 to S1004 of FIG. 14, and description thereof will not be provided. In step S2005, the second superimposing unit 65 calculates the allowable value surfaces based on the interval of the multiple viewpoints and the information representing the characteristics of the light beams emitted from the display unit 50 and superimposes the allowable lines that represent the allowable value surfaces as viewed from the depth viewpoint on the superimposed image, respectively. In step S2006, the image combining unit 45 combines the respective parallax images of the volume data with the image in which the allowable lines are superimposed on the superimposed image. In step S2007, the output unit 60 displays the image combined by the image combining unit 45 on the display unit 50.

As described above, in the present embodiment, since the image in which the allowable lines are superimposed on the superimposed image is displayed on the display unit 50, the viewer can recognize the display limit of the volume data easily. Moreover, since the region of the volume data in which the resolution when the parallax image is displayed on the display unit 50 as a stereoscopic image is smaller than the allowable value is not displayed, it is possible to improve the visibility of the image within the display limit of the volume data.

### Modification of Second Embodiment

For example, the third setting unit 48 may changeably set (change) the allowable value according to the input by the viewer. A method of allowing the viewer to input the allowable value is optional. For example, the average luminance value may be input by the viewer operating an operating device such as a mouse or a keyboard, and the allowable value may be input by the viewer performing a touch operation on the screen displayed on the display unit 50. Moreover, the second superimposing unit 65 changes the allowable lines according to the allowable value set by the third setting unit 48 and superimposes the changed allowable lines on the superimposed image. Moreover, the parallax image generating unit 420 changes the parallax image according to the allowable value set by the third setting unit 48. In this example, the allowable lines displayed on the display unit 50 in a state where the setting of the third setting unit 48 are not reflected will be referred to as default allowable lines and the stereoscopic image of the volume data will be referred to as a default stereoscopic image.

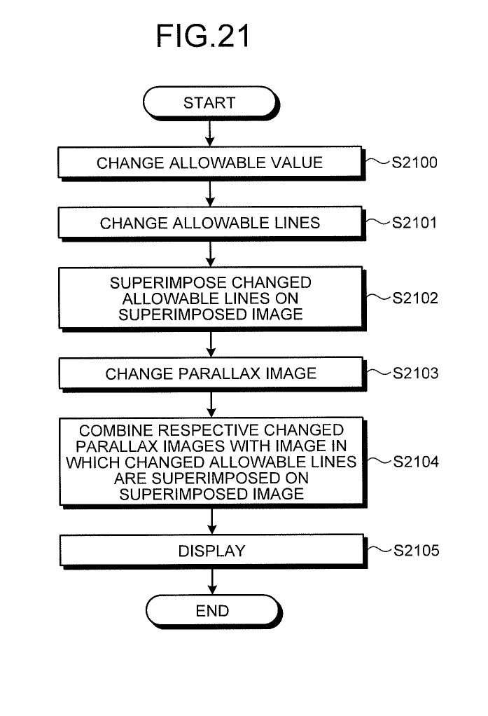

Next, an operation example of a stereoscopic image display apparatus when a viewer performs an input operation of changing the allowable value while viewing an image in which the default allowable lines are superimposed on the superimposed image or the default stereoscopic image will be described. FIG. 21 is a flowchart illustrating an operation example of the stereoscopic image display apparatus of this case. First, in step S2100, the third setting unit 48 sets (changes the allowable value according to the input by the viewer. In step S2101, the second superimposing unit 65 changes (regenerates) the allowable lines according to the allowable value set by the third setting unit 48. In step S2102, the second superimposing unit 65 superimposes the changed allowable lines on the superimposed image. In step S2103, the parallax image generating unit 420 changes (regenerates) the parallax image according to the allowable value set by the third setting unit 48. The process of step S2103 may be performed earlier than the processes of steps S2101 and S2102 and may be performed in parallel with the processes of steps S2101 and S2102.

In step S2104, the image combining unit 45 combines the respective changed parallax images of the volume data with the image in which the changed allowable lines are superimposed on the superimposed image. In step S2105, the output unit 60 displays the image combined by the image combining unit 45 on the display unit 50.

### Third Embodiment

Next, a third embodiment will be described. The third embodiment is different from the respective embodiments in that the isolines are superimposed on a depth image in which a cross-section-of-interest including at least a part of a region of interest of the volume data that the viewer wants to focus on is exposed to obtain and display a superimposed image. This will be described in detail below. The same portions as those of the respective embodiments described above will be denoted by the same reference numerals, and description thereof will not be provided.

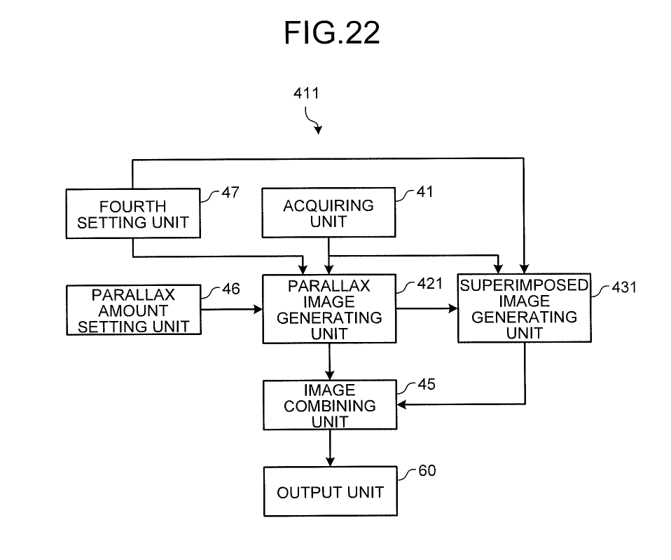

FIG. 22 is a diagram illustrating a configuration example of an image processing unit 411 according to the third embodiment. As illustrated in FIG. 22, the image processing unit 411 is different from that of the first embodiment in that the image processing unit 411 further includes a fourth setting unit 47. The fourth setting unit 47 changeably sets a region of interest representing a region of the volume data that the viewer wants to focus on according to the input by the viewer.

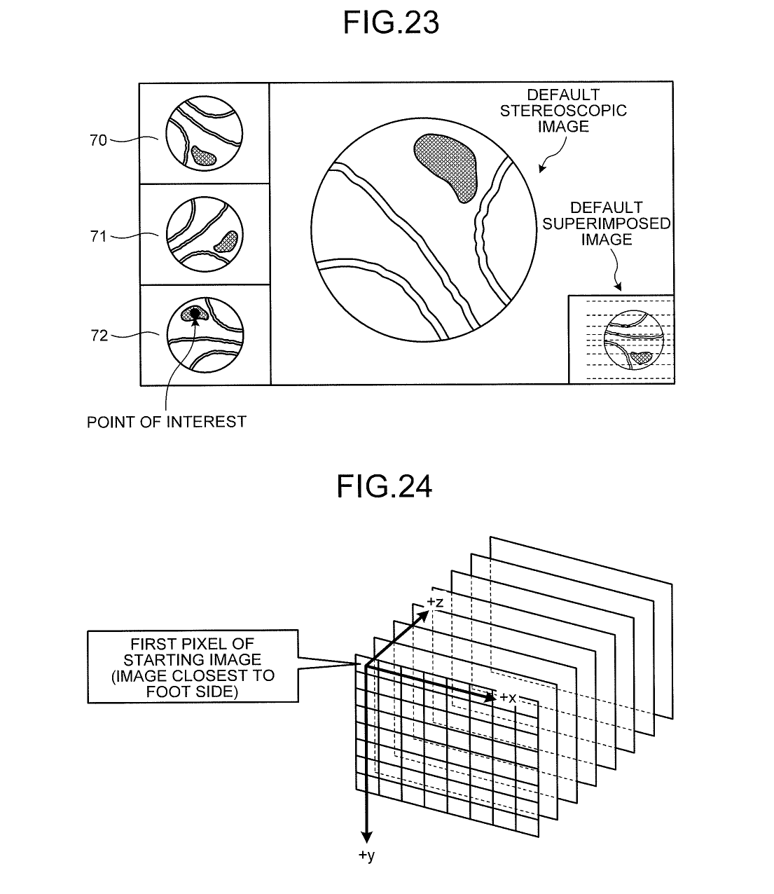

In this example, the stereoscopic image and the superimposed image of the volume data displayed on the display unit 50 in a state where the region of interest is not set will be referred to as a default stereoscopic image and a default superimposed image, respectively, and both images will be referred to as default images when both images are not distinguished. FIG. 23 is a diagram illustrating an example of a default image displayed on the display unit 50. In the example of FIG. 23, cross-sectional images (70 to 72) of three items of volume data are displayed on the display unit 50 in addition to the default image.

In this example, as illustrated in FIG. 24, original images (slice images) that configure volume data are arranged in the direction from the foot of a subject to the head, and the first pixel of the starting image is the first voxel of the volume data. In this example, the first voxel is the origin, and the coordinate value thereof is (0, 0, 0). In this example, a coordinate system is defined such that an arrangement direction of the original images is defined as the Z direction, the horizontal direction (lateral direction) of the original images is defined as the X direction, and the vertical direction (longitudinal direction) of the original images is defined as the Y direction. A cross-sectional image 70 is a cross-sectional image of the volume data along the XZ plane and is referred to as an axial cross-sectional image 70. A cross-sectional image 71 is a cross-sectional image of the volume data along the XY plane and is referred to as a coronal cross-sectional image 71. A cross-sectional image 72 is a cross-sectional image of the volume data along the YZ plane and is referred to as a sagittal cross-sectional image 72.

In this example, the viewer designates the cross-sectional positions of the three cross-sectional images 70 to 72 using a mouse cursor or the like by operating a mouse or the like, and the cross-sectional positions are changeably input according to a dragging operation of the mouse or the scroll value of a mouse wheel. Moreover, the cross-sectional images 70 to 72 corresponding to the input cross-sectional positions are displayed on the display unit 50. In this way, the viewer can change the cross-sectional images 70 to 72 displayed on the display unit 50. The present invention is not limited to this, and a method of changing the cross-sectional images 70 to 72 displayed on the display unit 50 is optional.

The viewer designates a predetermined position on a certain cross-sectional image as a point of interest while switching the three cross-sectional images 70 to 72. A method of designating the point of interest is optional, and for example, a predetermined position on a certain cross-sectional image may be designated using a mouse cursor by operating a mouse. In this example, the point of interest designated by the viewer is expressed as a 3-dimensional coordinate value within the volume data.

In the present embodiment, the fourth setting unit 47 sets a point of interest designated by the viewer as a region of interest. In this example, although the region of interest is a point present within the volume data, the present invention is not limited to this, and for example, the region of interest set by the fourth setting unit 47 may be a surface having a certain size. For example, the fourth setting unit 47 may set a region having an optional size including the point of interest designated by the viewer as the region of interest. Moreover, for example, the fourth setting unit 47 may set the region of interest using the volume data acquired by the acquiring unit 41 and the point of interest designated by the viewer. More specifically, for example, the fourth setting unit 47 may calculate the central positions of the respective objects included in the volume data acquired by the acquiring unit 41 and the distance between the central positions and the three-dimensional coordinate value of the point of interest designated by the viewer and set an object having the smallest distance as the region of interest. Further, for example, the fourth setting unit 47 may set an object having the largest number of voxels included in a region having a certain size including the point of interest among the objects included in the volume data as the region of interest. Furthermore, when an object is present within a threshold distance from the point of interest, the fourth setting unit 47 may set the object as the region of interest. When no object is present within the threshold distance from the point of interest, the fourth setting unit 47 may set a region having an optional size around the point of interest as the region of interest.

Moreover, for example, when the viewer designates (points) a predetermined position in a three-dimensional space on the display unit 50 using an input unit such as a pen while viewing a default stereoscopic image, the fourth setting unit 47 may set the region of interest according to the designation. In any case, the fourth setting unit 47 may have a function of setting a region of interest that represents a region of the volume data that the viewer wants to focus on according to the input by the viewer.

The description is continued by returning to FIG. 22. A parallax image generating unit 421 changes (for example, shifts in parallel) the positions of the multiple viewpoints and a point of regard at which the light beams from the respective cameras (viewpoints) converge so that a surface including the region of interest (in this example, the point of interest) set by the fourth setting unit 47 is displayed on the screen surface (in other words, the amount of parallax becomes minimum, for example, zero).

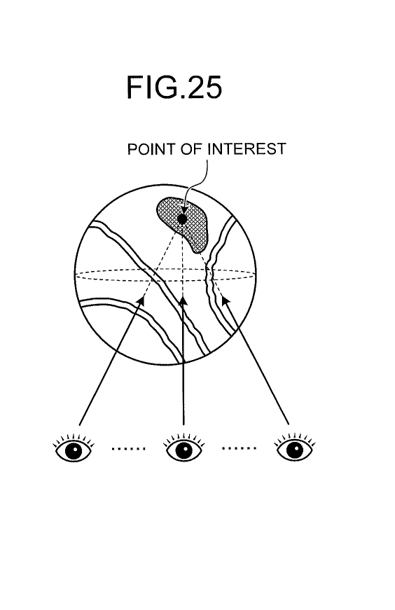

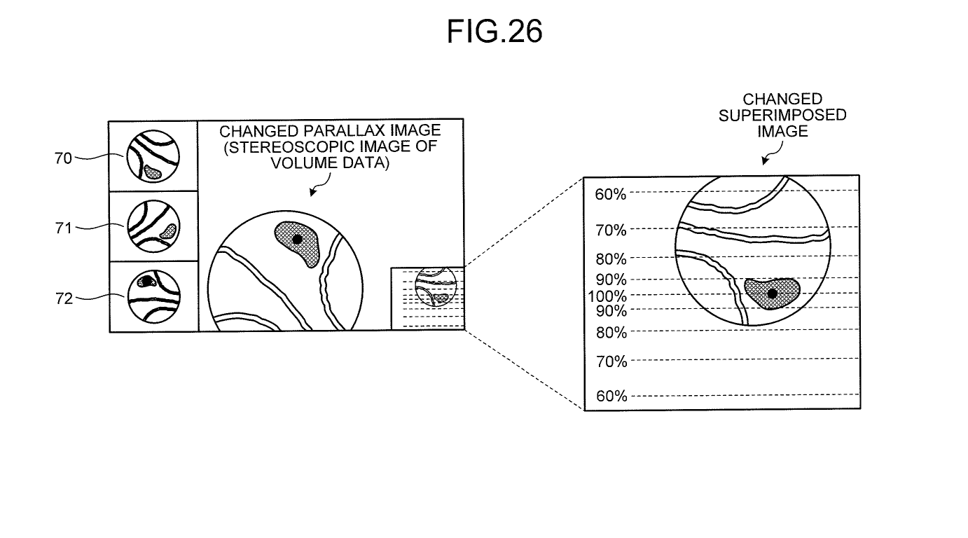

FIG. 25 is a diagram illustrating an example in which the positions of multiple viewpoints are shifted in parallel so that the point of regard is identical to the point of interest (region of interest). For example, when the region of interest set by the fourth setting unit 47 is a region having an optional size including the point of interest, the positions of the multiple viewpoints may be shifted in parallel so that the center (gravity center) of the region of interest is identical to the point of regard. As in FIG. 25, when the positions of the multiple viewpoints used when the parallax image of the volume data is rendered are shifted in parallel, the first viewpoint and the depth viewpoint are also shifted in parallel. The parallax image generating unit 421 changes (regenerates) the parallax image by rendering the volume data from the multiple changed viewpoints. Moreover, a superimposed image generating unit 431 changes (regenerates) the depth image by rendering the volume data from the changed depth viewpoint and changes (regenerates) the superimposed image by superimposing the isolines on the changed depth image. Moreover, the image combining unit 45 combines the changed superimposed image with the respective changed parallax images, and the output unit 60 displays the image combined by the image combining unit 45 on the display unit 50. As a result, the image displayed on the display unit 50 is changed similar to the example of FIG. 26.

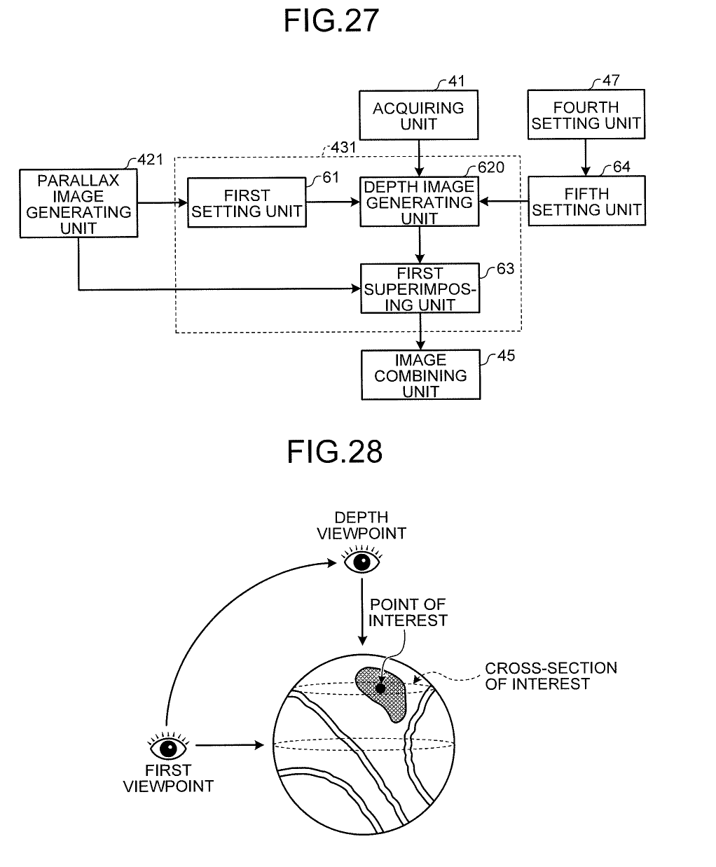

Next, a detailed configuration of the superimposed image generating unit 431 of FIG. 22 will be described. FIG. 27 is a diagram illustrating a detailed configuration example of the superimposed image generating unit 431. As illustrated in FIG. 27, the superimposed image generating unit 431 according to the third embodiment further includes a fifth setting unit 64.

The fifth setting unit 64 sets a cross-section of interest that represents a cross-section of the volume data including at least a part of the region of interest set by the fourth setting unit 47. In this example, the fifth setting unit 64 sets a cross-section of the volume data along the XZ plane including the point of interest (region of interest) set by the fourth setting unit 47 as the cross-section of interest. FIG. 28 is a diagram illustrating an example of the cross-section of interest set by the fifth setting unit 64. When the region of interest set by the fourth setting unit 47 is a surface having a certain size, the fifth setting unit 64 may set a cross-section of the volume data along the XZ plane including a part of the region of interest as the cross-section of interest and may set a cross-section of the volume data along the XZ plane including the entire region of interest as the cross-section of interest. In short, the fifth setting unit 64 may set a cross-section of the volume data including at least a part of the region of interest set by the fourth setting unit 47 as the cross-section of interest.

A depth image generating unit 620 generates a depth image so that the cross-section of interest is exposed. More specifically, the depth image generating unit 620 generates the depth image so that a region of the volume data present between the depth viewpoint and the cross-section of interest is not displayed. That is, the depth image generating unit 620 does not perform sampling along an arbitrary line of sight (ray of light) with respect to the region of the volume data present between the depth viewpoint and the cross-section of interest.

The first superimposing unit 63 generates a superimposed image by superimposing the isolines described above on the depth image generated by the depth image generating unit 620. The image combining unit 45 combines the respective parallax images with the superimposed image. Moreover, the output unit 60 displays the image combined by the image combining unit 45 on the display unit 50.

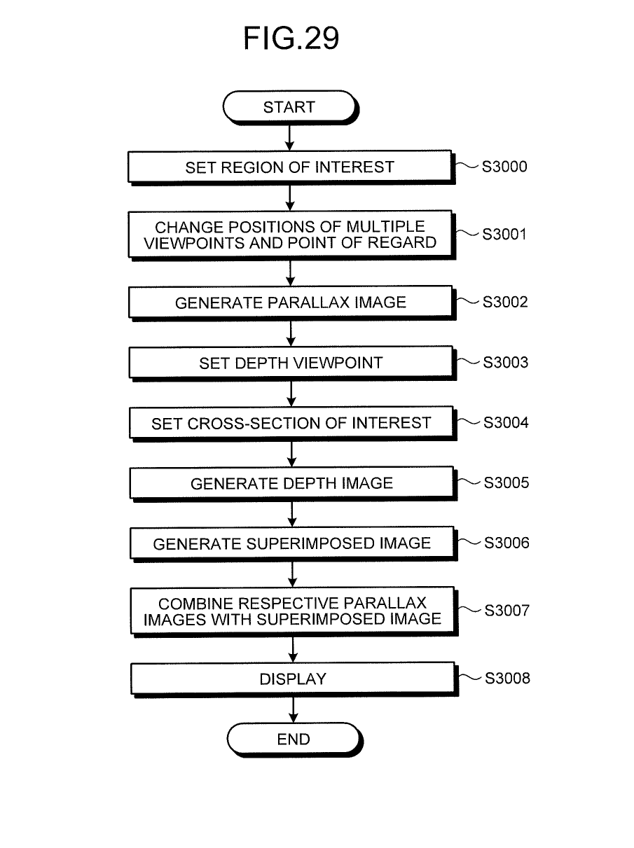

FIG. 29 is a flowchart illustrating an operation example of a stereoscopic image display apparatus when the viewer designates a predetermined position of a certain cross-sectional image as a point of interest while viewing the default image and the three cross-sectional images 70 to 72 displayed on the display unit 50.

As illustrated in FIG. 29, in step S3000, the fourth setting unit 47 sets a region of interest (in this example, a point of interest) that represents a region of the volume data that the viewer wants to focus on according to the input by the viewer. In step S3001, the parallax image generating unit 421 shifts the positions of the multiple viewpoints and the point of regard in parallel so that a plane including the region of interest set by the fourth setting unit 47 is displayed on the screen surface. In step S3002, the parallax image generating unit 421 generates a parallax image by rendering the volume data from the multiple changed viewpoints. In step S3003, the first setting unit 61 sets the depth viewpoint again. In step S3004, the fifth setting unit 64 sets a cross-section of interest that represents a cross-section of the volume data along the XZ plane including the point of interest. In step S3005, the depth image generating unit 620 generates the depth image so that the cross-section of interest is exposed. In step S3006, the first superimposing unit 63 generates the superimposed image by superimposing the isolines on the depth image. In step S3007, the image combining unit 45 combines the respective parallax images with the superimposed image. In step S3008, the output unit 60 displays the image combined by the image combining unit 45 on the display unit 50.

As described above, in the present embodiment, since isolines are superimposed on a depth image in which a cross-section of interest of the volume data including the point of interest that the viewer wants to focus on is exposed to obtain and display a superimposed image, the viewer can understand the resolution near the point of interest more easily.

### Modification of Third Embodiment

For example, when the region of interest set by the fourth setting unit 47 is a surface having a certain size, the depth image generating unit 620 may generate a depth image so that the region of interest set by the fourth setting unit 47 is exposed. For example, when the point of interest designated by the viewer belongs to any one of the respective objects included in the volume data such as a bone, a blood vessel, a nerve, or a tumor, the fourth setting unit 47 may set an object to which the point of interest belongs as the region of interest, and the depth image generating unit 620 may generate the depth image so that the region of interest (the object to which the point of interest belongs) set by the fourth setting unit 47 is exposed. In this case, the fifth setting unit 64 may be not provided.

The respective embodiments and the respective modification examples described above may be combined with each other. Moreover, the image processing unit (40, 400, 410, 411) of the respective embodiments described above corresponds to an image processing apparatus of the present invention.

The image processing unit (40, 400, 410, 411) of the respective embodiments described above has a hardware configuration which includes a central processing unit (CPU), a ROM, a RAM, a communication I/F device, and the like. The functions of the respective units are realized when the CPU deploys the programs stored in the ROM onto the RAM and executes the programs. Moreover, the present invention is not limited to this, and at least a part of the functions of the respective units may be realized by an individual circuit (hardware).

Moreover, the programs executed by the image processing unit of the respective embodiments may be stored on a computer connected to a network such as the Internet and may be provided by being downloaded via the network. Further, the programs executed by the image processing unit of the respective embodiments may be provided or distributed via a network such as the Internet. Further, the programs executed by the image processing unit of the respective embodiments may be provided by being incorporated in advance in a nonvolatile recording medium such as a ROM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising:
an acquiring unit configured to acquire volume data of a three-dimensional image; and
a superimposed image generating unit configured to generate a superimposed image that is made by superimposing light information on a depth image when a parallax image obtained by rendering the volume data from multiple viewpoints is displayed as a stereoscopic image, the light information representing a relationship between a position in a depth direction of the stereoscopic image and resolution of the stereoscopic image, the depth image being obtained by rendering the volume data from a depth viewpoint at which the entire volume data in the depth direction is viewable.

2. The image processing apparatus according to claim 1, wherein
the superimposed image generating unit includes
a first setting unit configured to select one of the multiple viewpoints and sets a viewpoint on a plane whose normal line corresponds to a straight line perpendicular to a vector that extends from the selected viewpoint in a sight direction as the depth viewpoint,
a depth image generating unit configured to generate the depth image, and
a first superimposing unit configured to calculate an isosurface that represents a surface on which the resolution is equal and to superimpose an isoline that represents the isosurface as viewed from the depth viewpoint on the depth image, the isoline indicating the light information.

3. The image processing apparatus according to claim 2, wherein
the first superimposing unit calculates the isosurface based on an interval of the multiple viewpoints and information that represents the characteristics of light beams emitted from a display unit that displays the superimposed image.

4. The image processing apparatus according to claim 1, further comprising a parallax image generating unit configured to generate a parallax image obtained by rendering the volume data from the multiple viewpoints.

5. The image processing apparatus according to claim 4, further comprising:
a second setting unit configured to changeably set the light information or a positional relationship between the depth image and the light information in accordance with an input by a viewer; and
a parallax amount setting unit configured to set an interval of the multiple viewpoints, wherein
the parallax amount setting unit changes the interval of the multiple viewpoints in accordance with a content of the setting of the second setting unit,
the parallax image generating unit changes the parallax image by rendering the volume data from the multiple viewpoints of which the interval has been changed by the of parallax amount setting unit, and
the superimposed image generating unit changes the superimposed image in accordance with the content of the setting of the second setting unit.

6. The image processing apparatus according to claim 1, wherein the superimposed image generating unit further includes a second superimposing unit configured to calculate an allowable value surface that represents a surface on which the resolution is equal to a predetermined allowable value and to superimpose an allowable line that represents the allowable value surface as viewed from the depth viewpoint on the superimposed image.

7. The image processing apparatus according to claim 6, further comprising a parallax image generating unit configured to generate a parallax image obtained by rendering the volume data from the multiple viewpoints, wherein
the parallax image generating unit renders the volume data so that a region of the volume data in which the resolution when the parallax image is displayed as the stereoscopic image is smaller than the allowable value is not displayed.

8. The image processing apparatus according to claim 6, further comprising a third setting unit configured to changeably set the allowable value according to an input by a viewer.

9. The image processing apparatus according to claim 4, further comprising:
a fourth setting unit configured to changeably set a region of interest of the volume data that a viewer wants to focus on in accordance with an input by the viewer; and
a fifth setting unit configured to set a cross-section-of-interest that represents a cross-section of the volume data including at least a part of the region of interest, wherein
the superimposed image generating unit generates the depth image so that the cross-section of interest is exposed.

10. The image processing apparatus according to claim 4, further comprising a fourth setting unit configured to changeably set a region of interest of the volume data that a viewer wants to focus on in accordance with an input by the viewer, wherein
the superimposed image generating unit generates the depth image so that the region of interest is exposed.

11. The image processing apparatus according to claim 9, wherein the parallax image generating unit changes the positions of the multiple viewpoints and a point of regard so that a plane including the region of interest is displayed on a screen surface that neither pops out nor sinks in a stereoscopic view.

12. The image processing apparatus according to claim 10, wherein the parallax image generating unit changes the positions of the multiple viewpoints and a point of regard so that a plane including the region of interest is displayed on a screen surface that neither pops out nor sinks in a stereoscopic view.

13. A stereoscopic image display apparatus comprising:
an acquiring unit configured to acquire volume data of a three-dimensional image; and
a superimposed image generating unit configured to generate a superimposed image that is made by superimposing light information on a depth image when a parallax image obtained by rendering the volume data from multiple viewpoints is displayed as a stereoscopic image, the light information representing a relationship between a position in a depth direction of the stereoscopic image and resolution of the stereoscopic image, the depth image being obtained by rendering the volume data from a depth viewpoint at which the entire volume data in the depth direction is viewable; and
a display unit configured to display the superimposed image.

14. An image processing method comprising:
acquiring volume data of a three-dimensional image; and
generating a superimposed image that is made by superimposing light information on a depth image when a stereoscopic image including multiple parallax images obtained by rendering the volume data from multiple viewpoints is displayed on a display unit, the light information representing a relationship between a position in a depth direction of the stereoscopic image and resolution of the stereoscopic image, the depth image being obtained by rendering the volume data from a depth viewpoint at which the entire volume data in the depth direction is viewable.

15. A computer program product comprising a computer-readable medium containing a program executed by a computer, the program causing the computer to execute:
acquiring volume data of a three-dimensional image; and
generating a superimposed image that is made by superimposing light information on a depth image when a stereoscopic image including multiple parallax images obtained by rendering the volume data from multiple viewpoints is displayed on a display unit, the light information representing a relationship between a position in a depth direction of the stereoscopic image and resolution of the stereoscopic image, the depth image being obtained by rendering the volume data from a depth viewpoint at which the entire volume data in the depth direction is viewable.
